(19) United States
(12) Patent Application Publication
(10) Pub. No.: US 2008/0315530 A1
(43) Pub. Date: Dec. 25, 2008

(54) Radial Shaft Seal

(76) Inventor: Michael vom Schemm, Reinfeld (DE)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 12/142,035

(22) Filed: Jun. 19, 2008

(30) Foreign Application Priority Data
Jun. 20, 2007 (DE) DE102007028893.1

(51) Int. Cl. F16J 15/32

(52) U.S. Cl. 277/549

(57) ABSTRACT

A radial shaft seal for a shaft or axle supported in a housing comprises a sealing element lying on the shaft made of a polymer material and a part fixed relative to the housing. The radial shaft seal for a shaft or axle can be supported in the drive train of a motor vehicle. The radial shaft seal can comprise a holding guide means supported on the shaft to hold the sealing element coaxial to the shaft. The holding guide means is connected to the part fixed relative to the housing by means of a flexible sealing membrane. The holding guide means at least in the contact area to the shaft is made of an essentially rigid material.

### RELATED APPLICATION

The application claims priority under 35 U.S.C. §119(e) of German Patent Application No. DE102007028893.1, filed on Jun. 20, 2007, which is hereby incorporated by reference in its entirety.

### FIELD OF INVENTION

Embodiments of the invention relate to a radial shaft seal for a shaft or axle supported in a housing. Specific embodiments pertain to a radial shaft seal for a shaft or axle supported in the drive train of a motor vehicle.

### BACKGROUND OF INVENTION

In conventional radial shaft seals with a sealing lip attached to a part fixed relative to the housing the contact pressure of the sealing lip changes with concentricity deviations of the shaft and the bore of the sealing ring as well as with radial deviations of the shaft. In the case of large deviations which lead to the exceeding of constructional tolerances, it can even come to a lifting of the sealing lip from the shaft in the worst case and consequently result in malfunction of the sealing ring. This problem is especially relevant with a radial shaft seal ring according to DE 100 33 446 C2, because the sealing ring has a substantially smaller radial contact pressure than conventional shaft seal rings with annular springs.

According to EP 1 696 154 A1 the above described problem is counteracted by means of an extended and especially formed sealing lip. Nevertheless, the fact that the contact pressure of the shaft changes with concentricity and radial deviations over the periphery of the shaft can negatively influence the sealing efficiency.

U.S. Pat. No. 2,743,950 discloses a radial shaft seal with an elastomer sealing lip which is preloaded by means of a spring and an elastomer guide ring supported on said shaft. The guide ring is built in one part with the sealing lip and is connected to a flange fixed relative to the housing via a flexible sealing membrane. In order to prevent an elliptic deformation of the elastomer guide ring an additional rigid or reinforcing ring member for pressing the guide ring against the shaft is provided.

U.S. Pat. No. 4,369,208 and U.S. Published Application No. 2006-0245674 A1 disclose radial shaft seals with an elastomer sealing element and a support part for holding the sealing element. The support part is connected to a flange fixed relative to the housing via a flexible sealing membrane. Due to the missing support of the support part on the shaft a possible off-center shift has to be taken up by the sealing lip.

### BRIEF SUMMARY

An object of the invention consists is to provide a radial shaft seal the function of which is not impaired by large concentricity and radial deviations of the shaft.

Embodiments of the invention solve this object. The holding guide means mounted on the shaft holds the sealing element coaxial to the shaft independent of a radial shift of the shaft. The contact pressure of the sealing lip on the shaft is therefore approximately constant over the circumference of the shaft, independent of any radial shift of the shaft. Radial shift of the shaft is compensated by a flexible static sealing membrane between the holding guide means and the fixed housing part instead of the dynamic sealing element. According to embodiments of the invention, therefore, the compensation of a radial shift of the shaft is functionally decoupled from the dynamic sealing.

According to embodiments of the invention the holding guide means at least in the contact area to the shaft consists of an essentially rigid material, in particular an essentially rigid plastic, in order to be able to take up the radial forces exerted by the shaft without own deformation and therefore to release the sealing lip from this function. According to embodiments of the invention it is therefore possible to dispense with an additional rigid or reinforcing ring member for pressing the holding guide means against the shaft. Essentially rigid means that the material has a higher rigidity than elastomer. Essentially rigid plastic generally comprises any non-elastomer plastic in particular on the basis of a thermoplastic or a thermosetting plastic. Reinforced plastics are preferred.

The support of the holding guide means is preferably arranged on the inside of the sealing lip, that means, in the space to be sealed in order to be able to use the medium in the space to be sealed for lubricating the support. Embodiments of the invention are delimited by these features from any radial shaft seal in which a protective lip of the sealing element which is non-lubricated on the atmosphere side and therefore subject to wear is used to guide the sealing lip. The holding guide means can also be formed in one piece or integral with the sealing element of an essentially rigid material, for example a PTFE material.

Preferably, the holding guide means comprises a holding part, to which the sealing element is bonded on the inside and to which the sealing membrane is bonded on the outside, wherein the support of the holding guide means on the shaft is effected by a guide element guiding the holding guide means. The separation into a holding part and a guide element allows the choice of respective suitable materials. The guide element is preferably made of an essentially rigid material, in particular an essentially rigid plastic. However, the holding part and the guide element can also be made in on piece or integral of an essentially rigid material, which has the advantage of a reduced number of parts.

### BRIEF DESCRIPTION OF DRAWINGS

The invention is explained in detail in the following on the basis of preferable embodiments with reference to the enclosed drawings. In the drawings:

FIG. 1 shows a center cross-section through a radial shaft seal in an embodiment with the holding part and the guide part; and

FIG. 2 shows a center cross-section through a radial shaft in a further embodiment with a holding guide part.

### DETAILED DISCLOSURE

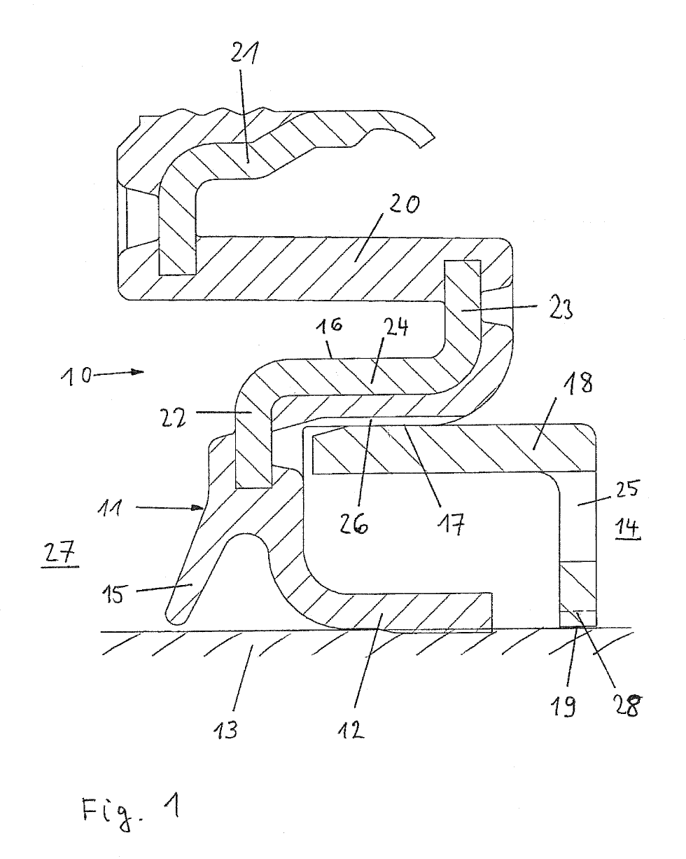

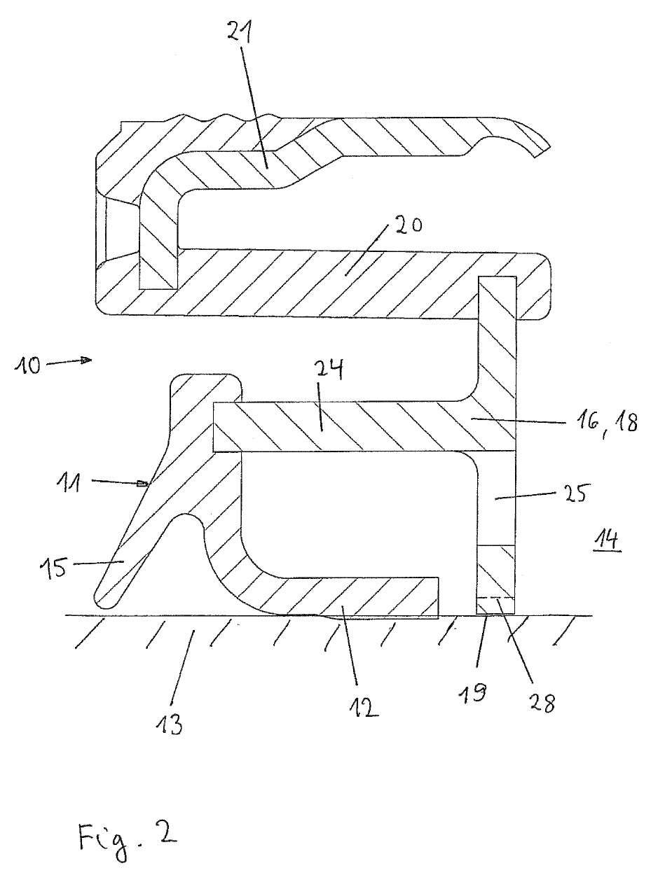

Referring to FIGS. 1 and 2, the radial shaft seal 10 includes a sealing element 11 with a sealing lip 12, which lies about a certain axial length on the shaft 13 and in the operating state according to FIG. 1 is curved, funnel-shaped, to the space 14 to be sealed. The sealing element 11 is executed without an annular spring for the pressing on of the sealing lip 12 to the shaft 13. On the periphery side 27, the sealing element 11 can have a protective lip 15 that prevents the penetration of debris in the sealing gap between the sealing lip 12 and shaft 13.

The sealing element 11 is connected to a holding part 16 in a firmly bonded manner and is held by the latter. The holding part 16 comprises a reception 17 for a guide part 18 that seats in a bore 19 on the shaft 13. The guide part 18 is guided by the shaft 13 with each offset diagonally to the middle axis and correspondingly guides the holding part 16 so that also the sealing element 11 held by the holding part 16 follows every radial run-out of the shaft 13. On the basis of this guide, the position of the sealing lip 12 relative to the shaft 13 is constantly coaxially independent of the position of the shaft 13 and the contact pressure of the sealing lip 12 on the shaft 13 is held at least approximately constant over the entire periphery.

On its outer periphery, a flexible membrane 20 is connected to the holding part 16, whose other end is attached to the load-carrying portion 21, which, in particular, can be part of a sealing flange or of a housing part of the internal combustion engine. The membrane 20 completely seals the opening between the load-carrying portion 21 and the holding part 16. The membrane 20, due to its flexibility and elasticity as well as its length, is capable of compensating also large radial run-outs and reliably seals radial deviations of the shaft 13. The membrane 20 is preferably tubular formed and arranged approximately coaxially to the shaft 13 in order to keep the radial dimensions low. The holding part 16 is preferably formed double-curved with an end section 22 bent over radially for connecting to the sealing element 11, an end section 23 bent over radially for connecting the membrane 20 and a cylindrically formed center section 24 extending coaxially between the end sections.

Preferably, the guide part 18 is rotatably supported on the shaft 13. In order to achieve a sufficient lubrication of the guide part 18 on the shaft 13, the guide part 18 comprises on the periphery of the bore 19 preferably at least one oil passage. Especially preferred is a shaft-shaped structure 28 along the periphery of the bore 19 to form a hydrodynamic lubricating film.

Preferably the guide part 18 is a separate component. This enables that the materials for the guide part 18 and the holding part 16 are selected according to the respective requirements. In view of possible friction occurring between the guide part 18 and the shaft 13, the guide part 18 is preferably made of a sufficiently wear-resistant material. Particularly suitable is a reinforced non-elastomer plastic, for example fiberglass reinforced polyamide. The material of the holding part 16 is suitably selected in view of the connection of the sealing element 11 and the membrane 20 and can be a metal, in particular steel, or a suitable plastic. The sealing element 11 consists preferably of an elastomer material, in particular rubber, or a PTFE material. The load-bearing part 21 can be of metal, in particular steel, or a suitable plastic.

Preferably, the guide part 18 is axially rotatably supported in the holding part 16. Thereby the torque transferred from the shaft 13 via the guide part 18 to the holding part 16 can be reduced, if required. The guide part 18, accordingly, is preferably executed cylindrically and arranged coaxially to the shaft 13 while the reception 17 of the holding part 16 in this case is suitably executed as a cylindrical bore.

Through an inner seat provided with grooves 26 the pressing in of part 18 in the bore 17 is facilitated. At the same time, the grooves 26 as well as the oil passages 25 in the guide part 18 serve the exchange of the medium to be sealed.

The guide part 18 does not necessarily have to be a separate component part. In the embodiment shown in FIG. 2 the holding part 18 and the guide element 16 are formed in one piece of a suitable material as an integral holding guide part.

The shaft 13 is in particular part of a gear, an axle or the internal combustion engine of a motor vehicle.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

1. A radial shaft seal for a shaft or axle supported in a housing, comprising:
a sealing element lying on the shaft, wherein the sealing element is made of a polymer material; and
a part fixed relative to the housing, wherein the radial shaft seal comprises a holding guide means supported on the shaft to hold said sealing element coaxial to the shaft, wherein said holding guide means is connected to said part fixed relative to the housing by means of a flexible sealing membrane, wherein said holding guide means at least in the contact area to the shaft is made of an essentially rigid material.

2. The radial shaft seal according to claim 1, wherein the holding guide means at least in the contact area to the shaft consists of a material on the basis of a non-elastomer plastic.

3. The radial shaft seal according to claim 1, wherein a support of said holding guide means on the shaft is arranged in the space to be sealed.

4. The radial shaft seal according to claim 1, wherein said holding guide means includes a guide element supported on the shaft and a holding part holding said sealing element and being guided by said guiding element.

5. The radial shaft seal according to claim 4, wherein said guiding element is made of an essentially rigid material.

6. The radial shaft seal according to claim 4, wherein said guiding element is made of a reinforced plastic.

7. The radial shaft seal according to claim 4, wherein between said guiding element and said holding part at least one oil passage channel is formed.

8. The radial shaft seal according to claim 7, wherein said oil passage channel is formed by a groove in said holding part.

9. The radial shaft seal according to claim 1, wherein said holding guide means comprises at least one oil passage bore.

10. The radial shaft seal according to claim 1, wherein said holding guide means comprises a bore for the shaft.

11. The radial shaft seal according to claim 10, wherein said bore comprises a profile wave-shaped in the peripheral direction.

12. The radial shaft seal according to claim 1, wherein said sealing element comprises a funnel-shaped sealing lip lying on the shaft.

13. The radial shaft seal according to claim 1, wherein the radial shaft seal is supported in the drive train of a motor vehicle.

14. The radial shaft seal according to claim 5, wherein said guiding element is made of a non-elastomer plastic.
